(19) United States
(12) Patent Application Publication
(10) Pub. No.: US 2007/0216588 A1
(43) Pub. Date: Sep. 20, 2007

(54) Emblem-mark-attached car antenna

(76) Inventor: Chih-Yuan Hsueh, Tauyuan Hsien (TW)

Correspondence Address: Hsueh, Chih-Yuan, 20525 Via Talavera, Yorba Linda, CA, 92887, US

(21) Appl. No.: 11/373,905

(22) Filed: Mar. 14, 2006

(51) Int. Cl. H01Q 1/32; H01Q 1/38

(52) U.S. Cl. 343/713; 343/700 MS

(57) ABSTRACT

An emblem-mark-attached car antenna includes an antenna sheet having a printed antenna for receiving wireless signals, and a car emblem mark having at least one rearward protruded rivet hole corresponding to a locating hole on the antenna sheet. When the rivet hole on the emblem mark is rearward extended through the locating hole on the antenna sheet into a predetermined position on a car body, the antenna sheet is pressed by the emblem mark against the car body to locate on an outer surface of the car. A signal transmission line is extended between the printed antenna and an in-car wireless device to transmit wireless signals.

### FIELD OF THE INVENTION

The present invention relates to a car antenna, and more particularly to a printed antenna attached to a car emblem mark to advantageously receive external wireless signals.

### BACKGROUND OF THE INVENTION

A conventional antenna for an in-car radio or a radio communication device is usually an exposed or a hidden telescopic antenna. In using the conventional telescopic antenna, a user has to inconveniently manually extend or telescope the antenna. The telescopic antenna also adversely affects the appearance of a car, and is no longer widely accepted among consumers. There is another type of antenna, namely, printed antenna, for providing on a rear windshield of a car. While the printed antenna on the rear windshield is convenient for use and does not adversely affect the car appearance, it increases the manufacturing cost of the rear windshield. Since the printed antenna is integrally formed in the rear windshield, it must be discarded and can not be repeatedly used when the rear windshield is broken or damaged.

It is therefore tried by the inventor to develop a car antenna that eliminates the drawbacks existed in the conventional car antenna.

### SUMMARY OF THE INVENTION

A primary object of the present invention is to provide a car antenna invisibly attached to a rear side of a car emblem mark without adversely affecting the appearance of the car.

Another object of the present invention is to provide an emblem-mark-attached car antenna, which is almost not subject to damage when being used in normal conditions, and can be dismounted from the car for repeated use later when the car undergoes body repair.

To achieve the above and other objects, the emblem-mark-attached car antenna according to the present invention includes an antenna sheet having printed antenna provided thereon for receiving wireless signals, and a car emblem mark having at least one rearward protruded rivet hole corresponding to a locating hole on the antenna sheet. When the rivet hole on the emblem mark is rearward extended through the locating hole on the antenna sheet into a predetermined position on a car body, the antenna sheet is pressed by the emblem mark against the car body to locate on an outer surface of the car. Signals received by the printed antenna are transmitted via a signal transmission line to an in-car wireless device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an emblem-mark-attached car antenna according to a first embodiment of the present invention;

FIG. 2 is an enlarged assembled sectional view of the emblem-mark-attached car antenna of FIG. 1;

FIG. 3 is an exploded perspective view of an emblem-mark-attached car antenna according to a second embodiment of the present invention;

FIG. 4 is an enlarged assembled sectional view of the emblem-mark-attached car antenna of FIG. 3;

FIG. 5 shows a first example of application of the emblem-mark-attached car antenna of the present invention; and

FIG. 6 shows a second example of application of the emblem-mark-attached car antenna of the present invention.

### DETAILED DESCRIPTION OF THE PREFERRED EMBODIMENTS

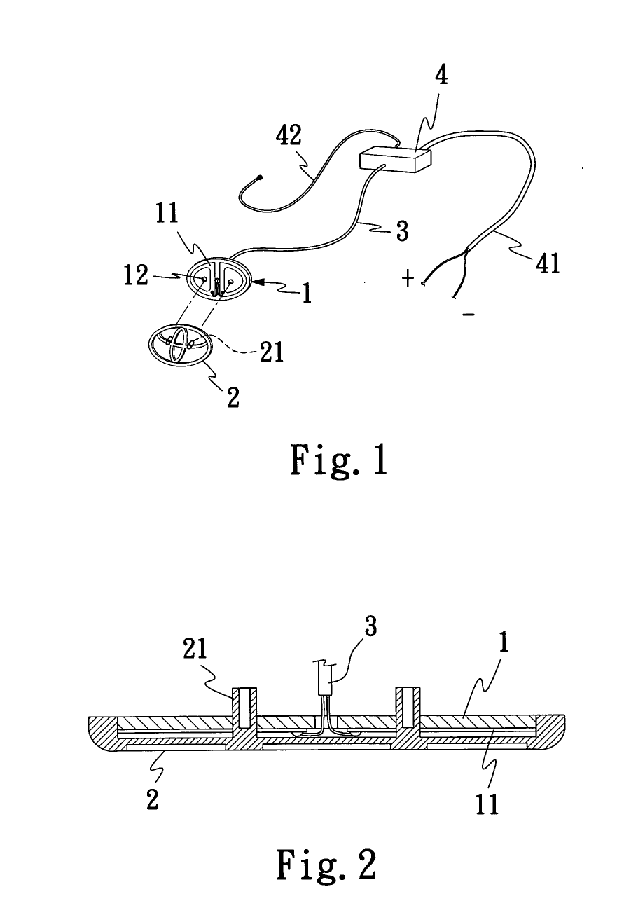

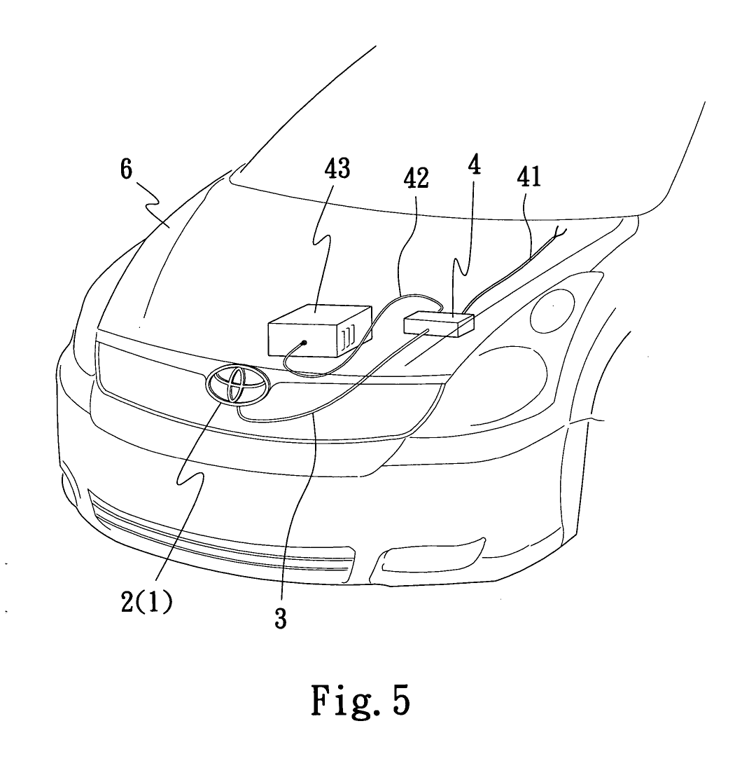

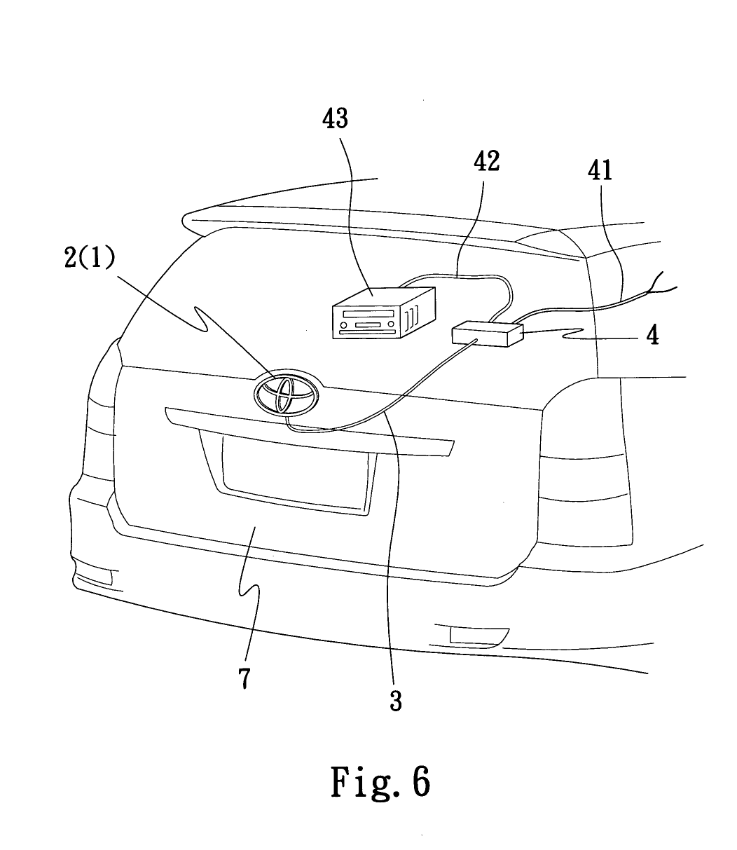

Please refer to FIGS. 1 and 2 that are exploded perspective view and enlarged assembled sectional view, respectively, of an emblem-mark-attached car antenna according to a first embodiment of the present invention. As shown, the emblem-mark-attached car antenna of FIG. 1 includes an antenna sheet 1 and a car emblem mark 2. The antenna sheet 1 is provided at a surface with a printed antenna 11 for receiving wireless signals. At least one locating hole 12 is provided on the antenna sheet 1 to extend therethrough. A signal transmission line 3 is welded at an end to the printed antenna 11 on the antenna sheet 1, and connected at the other end to a signal amplifier 4 or to an in-car wireless device, depending on actual need. A wireless signal received by the printed antenna 11 is primarily amplified at the signal amplifier 4 and then output via an output signal line 42 to an in-car wireless device 43 (see FIGS. 5 and 6). Power needed by the signal amplifier 4 is supplied thereto via a power cord 41. The car emblem mark 2 is provided at a rear side with at least one rearward protruded rivet hole 21 corresponding to the at least one locating hole 12 on the antenna sheet 1. To mount the emblem-mark-attached antenna, simply extend the rearward protruded rivet hole 21 of the emblem mark 2 through the locating hole 12 on the antenna sheet 1 into a predetermined position on a car body, so that the antenna sheet 1 is pressed by the emblem mark 2 against the car to firmly locate on an outer surface of the car body.

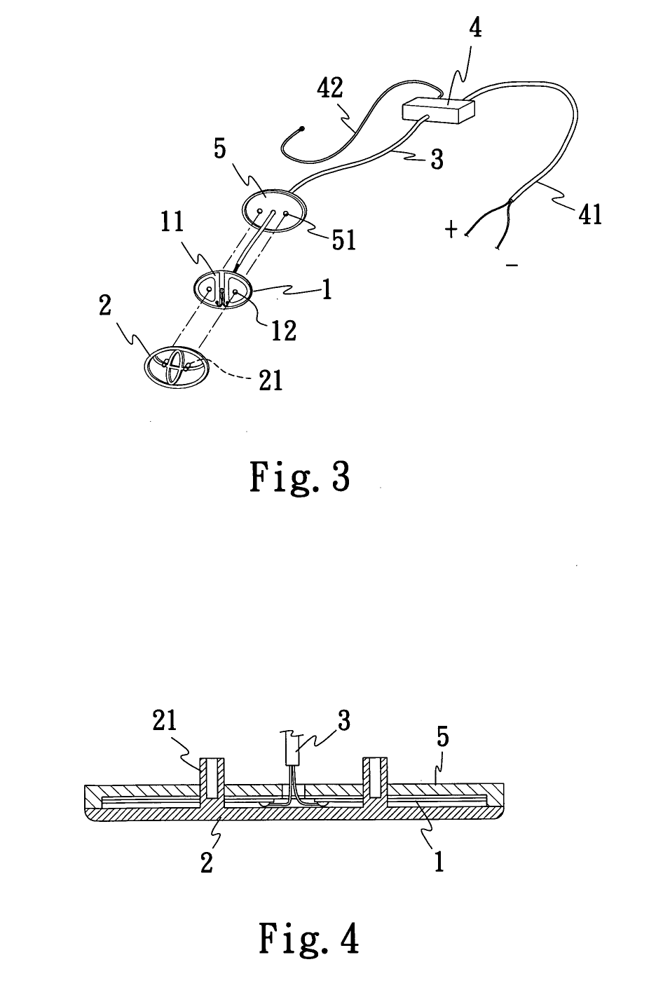

FIGS. 3 and 4 are exploded perspective view and enlarged assembled sectional view, respectively, of an emblem-mark-attached car antenna according to a second embodiment of the present invention. The emblem-mark-attached car antenna in the second embodiment is structurally similar to the first embodiment, except that a back cover 5 is further provided to locate at a rear side of the antenna sheet 1. The back cover 5 is provided with at least one mounting hole 51 corresponding to the rearward protruded rivet hole 21 on the emblem mark 2. To mount the emblem-mark-attached antenna, simply extend the rearward protruded rivet hole 21 of the emblem mark 2 through the locating hole 12 on the antenna sheet 1 and the mounting hole 51 on the back cover 5 into a predetermined position on a car body, so that the antenna sheet 1 is sandwiched between the emblem mark 2 and the back cover 5 and firmly located on an outer surface of the car body. The back cover 5 forms an excellent protection to the antenna sheet 1.

The emblem-mark-attached car antenna of the present invention may be fixed to different positions on a car, depending on the car manufacturers. FIGS. 5 and 6 show two examples of application of the emblem-mark-attached car antenna of the present invention. In the first example of application shown in FIG. 5, the car antenna is mounted on a hood 6 of a car. In the second example of application shown in FIG. 6, the car antenna is mounted on a back door or a trunk lid 7 of a car. With the antenna sheet 1 attached to the car emblem mark 2 and thereby located on an outer surface of a car body, the car antenna of the present invention is able to provide the best signal receiving effect.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An emblem-mark-attached car antenna, comprising:
a car emblem mark being provided at a rear side with at least one rearward protruded rivet hole for mounting to a predetermined position on an outer surface of a car body;
an antenna sheet being provided at one surface with a printed antenna for receiving wireless signals, and at a position corresponding to said at least one rivet hole on said emblem mark with at least one locating hole extended through said antenna sheet; and
a signal transmission line connecting said printed antenna on said antenna sheet to an in-car wireless device for transmitting wireless signals between said printed antenna and said wireless device; and
said antenna sheet being located on the outer surface of the car body by extending said rearward protruded rivet hole on said emblem mark through said locating hole on said antenna sheet into the predetermined position on the car body.

2. The emblem-mark-attached car antenna as claimed in claim 1, further comprising a back cover located behind said antenna sheet, said back cover being provided with at least mounting hole corresponding to said rearward protruded rivet hole on said emblem mark, such that said rivet hole on said emblem mark is rearward extended through said locating hole and said mounting hole on said antenna sheet and said back cover, respectively, into said car body, and said antenna sheet is sandwiched between said emblem mark and said back cover.

3. The emblem-mark-attached car antenna as claimed in claim 1 or 2, further comprising a signal amplifier located between said antenna sheet and said in-car wireless device for primarily amplifying a wireless signal received by said printed antenna and then outputting the amplified signal to said in-car wireless device.
